(19) United States
(12) Patent Application Publication
(10) Pub. No.: US 2026/0346261 A1
(43) Pub. Date: Nov. 5, 2026

(54) LABORATORY MILL, GRINDING BOWL FOR A LABORATORY MILL AND ARRANGEMENT WITH A LABORATORY MILL AND WITH A GRINDING BOWL

(71) Applicant: Retsch GmbH, Haan (DE)

(72) Inventors: Stefan DRECHSLER, Hattingen (DE); Bastian SONNTAG, Langenfeld (DE)

(73) Assignee: Retsch GmbH, Haan (DE)

(21) Appl. No.: 18/997,374

(22) PCT Filed: Apr. 5, 2023
(86) PCT No.: PCT/EP2023/058941

§ 371 Date: Jan. 21, 2025

(30) Foreign Application Priority Data
Jul. 21, 2022 (DE) 102022118218.9

(51) Int. Cl. B02C 17/18

(52) U.S. Cl. CPC B02C 17/182

(57) ABSTRACT

Shown and described is a laboratory mill, in particular centrifugal ball mill and/or planetary ball mill, having at least one grinding cup holder for at least one grinding cup (2) and having at least one anti-rotation means for holding the grinding cup (2) in a defined, predetermined position relative to the grinding cup holder and/or as a positioning aid. According to the invention, it is provided that the grinding cup holder has, on an axial surface (4) which faces a grinding cup base during grinding operation, at least one surface relief as anti-rotation means which can be connected in a form-fitting manner to a mating relief which is complementary to the surface relief on an axial surface (10) of the grinding cup base in order to form an anti-rotation means.

The invention relates to a laboratory mill, in particular a centrifugal ball mill and/or planetary ball mill, with at least one grinding cup holder for holding and/or receiving at least one grinding cup and with at least one anti-rotation means for holding the grinding cup in a defined, predetermined position relative to the grinding cup holder and/or as a positioning aid.

In addition, the present invention relates to a grinding cup for a laboratory mill of the aforementioned type and to an arrangement having a laboratory mill and at least one grinding cup.

In centrifugal mills, the grinding cups are arranged eccentrically with respect to a drive axis in the mill and thus move on a circular path around the drive axis. In centrifugal ball mills, the rotation of a grinding cup about its own axis is prevented. In contrast thereto, in planetary ball mills, a rotation of the grinding cup about its own axis additionally takes place, so that a planetary gear having a sun gear rotating around the center axis of the mill housing and at least one driven planet wheel which is arranged thereon, carries the grinding cup and rotates around the sun gear axis is formed.

In such mills, the grinding cups are filled outside the mill before each grinding operation, are subsequently closed by means of a cover which is placed thereon and are then set, for example, into a grinding cup receptacle of a grinding cup holder. Before the mill is started by switching on the drive, the grinding cups are fixed on the grinding cup holder by means of a prestressing device which is to be placed thereon after the grinding cup has been inserted into the grinding cup receptacle, in such a way that they are securely fastened even under the action of the considerable centrifugal forces which occur and do not present any risk to the operator.

Generic laboratory mills of the type of a planetary ball mill are known from DE 42 37 055C1, wherein a housing having a housing base is provided for holding and receiving a grinding cup. The housing is placed on and fixed on a rotating clamping plate which is a constituent part of a rotating sun gear. Each housing has webs which project laterally with respect to the grinding cup and have openings for receiving a multi-armed spider which engages over the grinding cup. A fixing screw which can be rotated via handles and clamps the grinding cup against the base of the housing engages through the spider. As a securing measure and positioning aid for inserting the grinding cup, it can be provided that the base of the housing has a pin which engages into the base of the grinding cup, wherein the pin is arranged acentrically with respect to the receiving axis in the base of the housing and a blind hole is arranged at a corresponding point of the grinding cup. The pin acts as an anti-rotation means. As a result, the grinding cup is fixed in a form-fitting manner with respect to the base of the housing, whereby travelling movements of the grinding cup are counteracted.

Caused by high forces as a result of rotational movements during operation of the planetary ball mill, the pin which engages into the base of the grinding cup as an anti-rotation means is subjected to a high surface pressure and thus to high. As a result of wear, bending can occur as far as the anti-rotation pin being torn off, with the result that the grinding cup is no longer fixed in a reliably form-fitting manner with respect to the base of the housing. In addition, as wear increases, exact positioning of the grinding cup during insertion into the housing is made more difficult.

It is an object of the present invention to provide a laboratory mill, a grinding cup and an arrangement in each case of the type mentioned at the outset which ensure reliable form-fitting fixing of a grinding cup to, in and/or on a grinding cup holder with low surface pressure and reduced wear of at least one anti-rotation means which is provided for fixing the grinding cup and which enable exact positioning of the grinding cup relative to the grinding cup holder in a simple manner.

The aforementioned objective is achieved according to the invention by a laboratory mill having the features of claim 1 and by a grinding cup having the features of claim 2. Advantageous developments of the invention are the subject matter of the dependent claims.

According to the invention, it is provided that the grinding cup holder has, on an axial surface which faces a grinding cup base during grinding operation, at least one surface relief or a surface topography as anti-rotation means which can be connected in a form-fitting manner to a mating relief which is complementary to the surface relief or to a corresponding complementary surface topography on an axial surface of the grinding cup base in order to form an anti-rotation means.

Accordingly, in a grinding cup according to the invention, a surface relief is provided on an axial surface, which faces a grinding cup holder of the laboratory mill during grinding operation, of a grinding cup base as anti-rotation means which can be connected in a form-fitting manner to a mating relief which is complementary to the surface relief on an axial surface of the grinding cup holder in order to form an anti-rotation means.

According to the invention, the anti-rotation means of the grinding cup thus takes place via complementary reliefs or profilings on the underside of the grinding cup base and the facing upper side of the grinding cup holder.

The terms “surface relief” and “mating relief” are to be interpreted as having the same meaning within the meaning of the invention.

According to the invention, a specific surface profiling or anti-rotation means geometry is provided on an axial upwardly directed surface, which faces the grinding cup, of the grinding cup holder and a complementary surface profiling is provided on an axial downwardly directed surface, which faces the grinding cup holder, of the grinding cup base in order, in the coupling state, that is to say after the surface profilings or anti-rotation means geometries have been connected in a form-fitting manner at least in regions on the mutually facing surfaces of the grinding cup holder and grinding cup base, to prevent a relative rotation of the grinding cup about its central axis. When the grinding cup is placed on or when the grinding cup is inserted into the grinding cup holder, the relief-like surface regions of the grinding cup base and of the grinding cup holder engage into one another at least in regions and/or come to bear against one another in the circumferential direction and thereby form a form fit in the circumferential direction in order to prevent a rotational movement of the grinding cup relative to the grinding cup holder about the axial central axis of the grinding cup.

In order to ensure an anti-rotation means of the grinding cup relative to the grinding cup holder, the surface relief and the mating relief in each case have a suitable complementary relief profile, that is to say which interacts within the meaning of an anti-rotation means and relates to the outer edges of the reliefs, in the circumferential direction of the grinding cup.

The effective anti-rotation means surfaces of the surface reliefs or surface topographies on the grinding cup holder and the grinding cup are formed by axial surface portions which extend in the axial direction, that is to say in the direction of the central axis of the grinding cup, on the mutually facing surfaces of the grinding cup holder and grinding cup during grinding operation and which, when the grinding cup is inserted into or placed on the grinding cup holder, prevent a rotational movement of the grinding cup relative to the grinding cup holder or bring about a form fit in the circumferential direction.

An anti-rotation pin which is provided as the sole anti-rotation means in the prior art is subjected to high wear on account of a small anti-rotation means surface during operation of the laboratory mill. The anti-rotation means surface of the pin is formed by its cylindrical lateral surface. As a result of the surface reliefs or surface topographies, which are provided according to the invention, of the mutually facing surfaces of the grinding cup holder and grinding cup during grinding operation, the effective anti-rotation means surface can be significantly increased with respect to the effective anti-rotation means surface or lateral surface of an anti-rotation pin, which leads to a reduction in the surface pressure and thus to a lower wear on the effective anti-rotation means surfaces. As a result of the axial surface portions, which interact according to the invention for a form fit in the circumferential direction, on the mutually facing surfaces of the grinding cup holder and grinding cup during grinding operation, the grinding cup is fixed in a form-fitting manner with respect to the base of the grinding cup holder over a long service life even in the case of high centrifugal forces, and travelling movements of the grinding cup are counteracted with high reliability.

A surface relief within the meaning of the invention is preferably formed by at least one surface region which is formed so as to be recessed or projecting in the axial direction with respect to an adjoining surface region of the surface, wherein, when the grinding cup is placed on or into a base of the grinding cup holder, at least one recessed or projecting surface region on an axial surface of the grinding cup base engages into at least one projecting or recessed surface region on an axial surface of the grinding cup holder. The complementary geometries of the reliefs or the complementary contour profiles of the outer edges of the reliefs are in each case selected such that a rotational movement of the grinding cup relative to the grinding cup holder after the joining together of recessed and projecting surface regions on the grinding cup base and the holding device is ruled out.

Particularly preferably, the relief surface merges in one piece into the adjoining surface of the grinding cup base or of the grinding cup holder or the surface relief is formed in the surface of the grinding cup base or of the grinding cup holder.

Further preferably, the surface relief has a planar relief surface. The recessed or projecting surface region forming the relief can have a constant height or depth over the entire relief extent with respect to an adjoining (planar) surface region of the grinding cup holder or of the grinding cup, in particular wherein the height or the depth can be between 1 and 5 mm, for example 2 mm.

In order to provide sufficiently large anti-rotation means surfaces and to reduce the wear on the surface relief during grinding operation, the surface relief can extend with respect to an outer edge of the relief in the circumferential direction at least over an angle of rotation about the central axis of the grinding cup of at least 30°, preferably over an angle of rotation of at least 60°, in particular over an angle of rotation of 180° or more. Particularly preferably, however, the surface relief is formed by a recess or elevation which extends continuously over the entire circumference of the grinding cup or is closed per se. However, a plurality of recesses or elevations which are separate from one another can also be provided in order to form a relief or anti-rotation means profile on the grinding cup base and/or on the grinding cup holder.

In a plan view of the relief surface or in a cross-sectional view through the surface relief with respect to a section transversely with respect to the central axis of the grinding cup (with respect to the arrangement of the grinding cup in the holding device during operation of the laboratory mill), the surface relief can have any desired contour profile of a radially inner or radially outer longitudinal or outer edge of the relief if, in the interaction with the mating relief, an anti-rotation means of the grinding cup is ensured by a form fit of the reliefs which is achieved in the circumferential direction. For this purpose, in a plan view of the relief surface, the surface relief can have a contour profile of at least one outer edge of the surface relief which deviates from the exact circular shape and/or from the exact annular shape, in particular wherein the outer edge has at least one change in the curvature behavior in sections in the circumferential direction, in particular wherein the outer edge forms an undercut for a form fit which acts in the circumferential direction with the mating relief.

In principle, the surface relief can have any desired relief geometry which is predetermined by the profile of a longitudinal or outer edge of the surface relief in the circumferential direction. Particularly preferably, the relief geometry can be approximated to the geometry of a plurality of teeth, wherein the contour line of a longitudinal or outer edge of the surface relief forms a plurality of teeth or spikes which can interact with complementary teeth or spikes of the mating relief in order to form a form-fitting coupling which acts in the circumferential direction. This configuration of the relief promotes the force distribution and ensures a broad application of force of the forces which occur as a result of the rotational movement of the components of the laboratory mill during grinding operation. Flower-shaped geometries can also be realized.

A particularly favorable wear behavior and an advantageous effect of the surface relief as a positioning aid during insertion or placing of the grinding cup into or onto the base of the grinding cup holder can be achieved if the surface relief has a wave-shaped profile, preferably at least in sections, of a radially inner and/or of a radially outer longitudinal or outer edge of the surface relief in the circumferential direction.

Tests carried out in connection with the invention have shown that a particularly favorable wear behavior of the surface relief can be achieved if, in a plan view of the relief surface and with respect to the profile of a radially inner and/or of a radially outer longitudinal or outer edge of the surface relief, the surface relief is flower-shaped or star-shaped in the circumferential direction with a plurality of radial bulges and radial indentations which follow one another in the circumferential direction, in particular wherein at least 3 radial bulges, furthermore in particular between 4 and 6 radial bulges, can be provided. By means of the bulges and indentations, relief cams are formed which enable the grinding cup to be placed into or onto the grinding cup holder merely in a defined position with respect to the grinding cup holder. This results in a handling advantage, in particular in connection with a prestressing device which has a spider which can be fixed to the grinding cup holder as an abutment for a spindle which prestresses the grinding cup against the grinding cup holder, since the spider can be prepositioned in a simple and exact manner. The relief cams of the flower-shaped or star-shaped surface relief promote the force distribution in the manner of a multi-tooth profile with a broad application of force.

The surface relief can have rounded edges and circumferential surfaces in order to facilitate the formation of a form-fitting connection to the mating relief. If the surface relief is flower-shaped or star-shaped and has a plurality of relief cams and relief vales arranged therebetween, the relief can have a flattened profile of the circumferential contour in the region of the relief cams and/or in the region of the relief vales. This results in a high wear resistance of the profile.

For a simplified centring of the grinding cup when the grinding cup is inserted into or placed on the base of the grinding cup holder, at least one centring relief can be formed in and/or on the surface of the grinding cup holder and/or in and/or on the surface of the grinding cup base, which centring relief, when the form-fitting connection between the surface relief and the mating relief is formed, interacts with a complementary centring relief on the grinding cup base or on the holding device in order to centre the grinding cup relative to the holding device.

For example, a centrically arranged recessed surface region (centring recess) can be provided on the axial surface of the grinding cup holder which faces the grinding cup base during grinding operation, which recessed surface region is connected in a form-fitting manner to a complementarily formed centrically arranged projecting surface region (centring projection) on the surface of the grinding cup base when the grinding cup is inserted into or placed on the base of the grinding cup holder. In particular, the centring recess or the centring projection can be formed by a central, in particular circular, planar surface portion of the axial surface.

Particularly preferably, a central, in particular circular, planar surface portion of the axial surface can be provided as a centring projection or as a centring recess which is delimited and/or surrounded, preferably over the entire circumference, by an in particular annularly extending surface relief, wherein the surface relief acts as an anti-rotation means in the manner described above.

In addition to the anti-rotation means which is realized according to the invention via complementary surface reliefs on the grinding cup holder and grinding cup base, wherein the reliefs are formed for holding the grinding cup in a defined, predetermined position relative to the axis of rotation and/or as a positioning aid, an additional anti-rotation means can be provided via at least one anti-rotation element, in particular an anti-rotation pin. In particular, the anti-rotation element can be provided for forming a form-fitting connection between the grinding cup holder and a grinding cup in the surface region of the surface relief. At least one anti-rotation pin can be provided which engages, axially parallel to the central axis of the grinding cup, into a bore which is made in a surface portion of the surface relief. If the surface relief is, for example, flower-shaped or star-shaped and has a plurality of relief cams and relief vales arranged therebetween, bores can be provided in the region of the relief cams for receiving a securing pin.

Even though the effective anti-rotation means surface, which is enlarged with respect to the circular shape, of the surface relief which is provided according to the invention as an anti-rotation means causes an increased wear resistance, wear phenomena can occur on the surface relief in the case of a long service life. In a preferred embodiment of the invention, therefore, the surface relief can be formed on a relief shaped piece which is detachably connected to the holding device or to the grinding cup, which permits the relief shaped piece to be exchanged as required depending on the state of wear.

Further advantages, features, properties and aspects of the present invention emerge from the claims and the following description of preferred exemplary embodiments with reference to the drawing, wherein the features of the exemplary embodiments can be combined with one another. In the drawing:

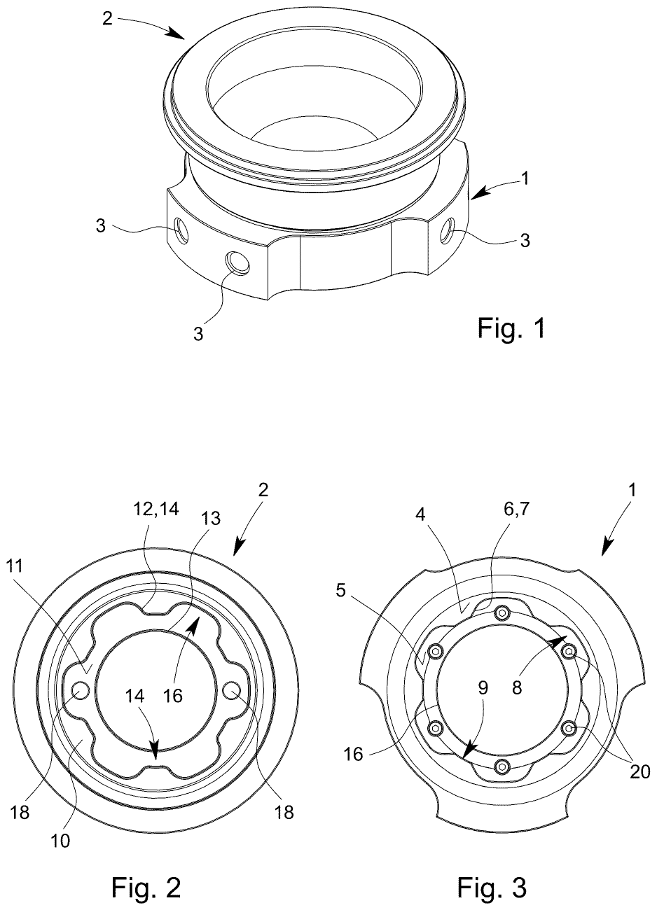

FIG. 1 a perspective view obliquely from above of an arrangement of a grinding cup according to the invention which is placed on and/or inserted into a disk-like base of a grinding cup holder (not shown in detail) of a laboratory mill according to the invention, in particular a planetary ball mill;

FIG. 2 a view of the grinding cup base of the grinding cup from FIG. 1 from below;

FIG. 3 a plan view of the base of the grinding cup holder from FIG. 1;

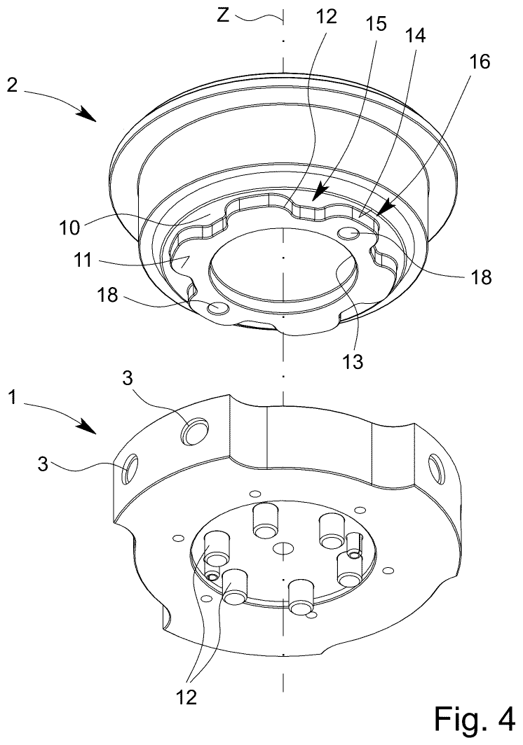

FIG. 4 a perspective view obliquely from below of the base and of the grinding cup of the arrangement shown in FIG. 1 before the grinding cup is placed on or inserted into the base;

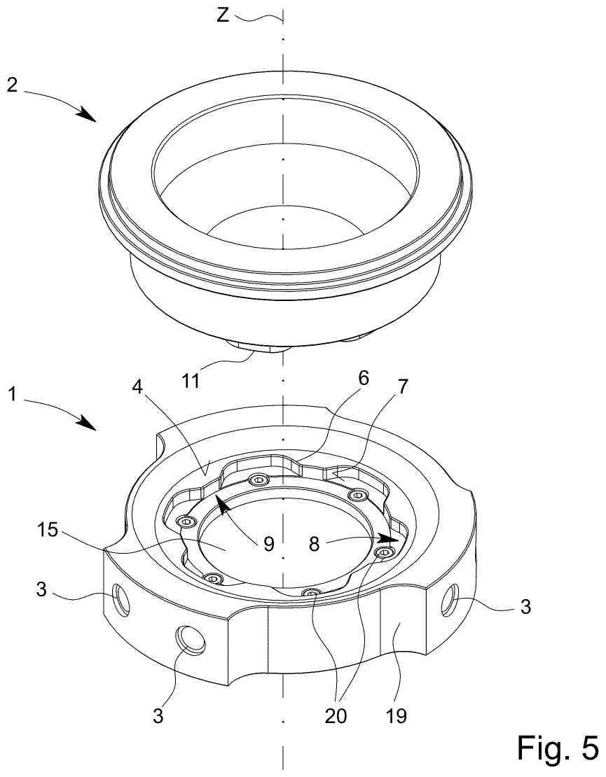

FIG. 5 a perspective view obliquely from above of the base and of the grinding cup of the arrangement shown in FIG. 1 before the grinding cup is placed on or inserted into the base;

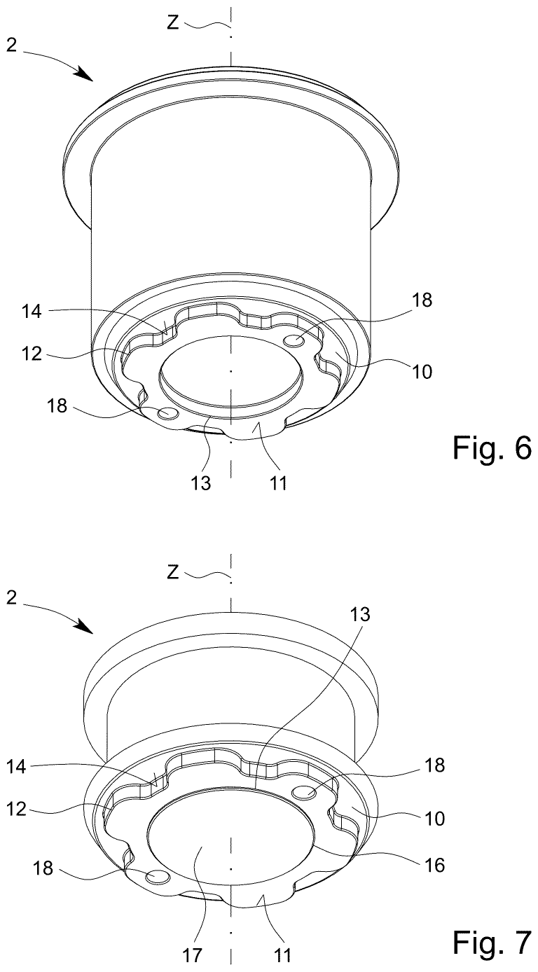

FIG. 6 a perspective view obliquely from below of a second embodiment of a grinding cup according to the invention and

FIG. 7 a perspective view obliquely from below of a third embodiment of a grinding cup according to the invention.

FIG. 1 shows an arrangement of a disk-like base 1 of a grinding cup holder (not shown in detail) of a laboratory mill, in particular a planetary ball mill, for at least one grinding cup 2 of the laboratory mill. The grinding cup holder can provide a holding and/or receiving device described in DE 20 2008 008 473 U1, wherein the grinding cup 2 can be placed on the base 1 and can be fixed by means of a prestressing device which comprises a spider which can be fixed against a grinding cup receptacle which is connected to the base 1 of the grinding cup holder and serves as an abutment for a spindle which clamps the grinding cup 2 against the base 1.

The grinding cup holder can also have a spatial-geometrical configuration which deviates from the holding and/or receiving device shown and described in DE 20 2008 008 473 U1. It is essential that the grinding cup holder is provided and formed for holding or fastening at least one grinding cup 2 of the laboratory mill.

In the embodiment shown in FIGS. 1 to 5, the base 1 is of disk-like form and has bores 3 on the shell side with an internal thread for fixing vertical tabs (not shown) which form a grinding cup receptacle, as is shown and described in DE 20 2008 008 473 U1.

According to FIGS. 3 and 5, the base 1 has, on its surface 4 which faces a grinding cup base of the grinding cup 2 during grinding operation, a planar surface region 5 which is recessed with respect to the adjoining surface 4 and which forms a surface relief of the base 1. The surface relief is delimited radially inwardly by an outer edge with a wave-shaped contour line 6. Axial surfaces 7 of the outer edge form anti-rotation means surfaces. The recessed planar surface region 5 is formed so as to extend continuously and is closed per se.

In the embodiment shown, the contour line 6 runs in a wave-shaped manner with radial indentations 8 and radial bulges 9 or contour cams.

According to FIGS. 2 and 4, the grinding cup base of the grinding cup 2 has, on its surface 10 which faces the base 1 of the grinding cup holder during grinding operation, a planar surface region 11 which projects with respect to the adjoining surface 10 and which forms a surface relief of the grinding cup base. The surface relief is delimited radially outwardly by an outer edge with a wave-shaped contour line 12 and radially inwardly by an outer edge with a circular contour line 13. Axial surfaces 14 of the outer edge form anti-rotation means surfaces. The projecting planar surface region 11 is formed so as to extend continuously and is closed per se.

In the embodiment shown, the contour line 12 runs in a wave-shaped manner with radial indentations 15 and radial bulges 16 or contour cams.

The projecting surface region 11 on the grinding cup base engages into the recessed surface region 5 of the base 1 in a form-fitting manner when the grinding cup is placed on the base 1 of the grinding cup holder, such that a form-fitting coupling of the grinding cup 2 to the base 1 is achieved in the circumferential direction of the grinding cup 2 or along a lateral surface of the grinding cup 2, which form-fitting coupling prevents a rotational movement of the grinding cup 2 about its central axis Z. Here, the axial surfaces 7, 14, which come to bear against one another, on the base 1 or the grinding cup base prevent a rotational movement of the grinding cup 2 about its central axis Z in the coupling state to the grinding cup holder on account of the selected complementary contour geometries of the outer edges of the surface reliefs. Here, the radially outwardly extending bulges 16 on the grinding cup base come to bear in a form-fitting manner in the circumferential direction against the radially inwardly extending bulges 9 on the base 1 of the grinding cup holder.

As results from FIG. 5, the base 1 of the grinding cup holder can have a centrically recessed surface region 15 with a circular base surface which is recessed with respect to an adjoining surface region 16 of the base 1, which surface region is in turn delimited by the contour line 6 of the surface relief on the base 1, and can have a depth of for example 1 to 5 mm.

As results from FIG. 7, the grinding cup base can have a centrically projecting surface region 17 with a circular base surface which is elevated with respect to the adjoining surface region 11 of the grinding cup base, which forms the relief surface of the surface relief on the grinding cup base, and can have a height of for example 1 to 2 mm.

When the grinding cup 2 is placed on the base 1, the projecting surface region 17 on the grinding cup base engages into the recessed surface region 15 on the base 1, such that the grinding cup 2 is centred. As a result, complementary centring means are formed on the grinding cup base and on the base 1 of the grinding cup holder, which centring means interact for centring the grinding cup and can be connected to one another in a form-fitting manner.

As further results from FIGS. 2, 6 and 7, bores 18 for receiving at least one anti-rotation pin (not shown) which is fixed to the base 1 can be provided as further anti-rotation means in the surface region 11 of the surface relief formed on the grinding cup base.

The surface relief on the grinding cup base and on the base 1 of the grinding cup holder in each case has rounded edges and a flattened profile in the region of the indentations 8, 16 and of the bulges 9, 15. This results in a high wear resistance of the profile. Moreover, the engagement of the reliefs into one another is simplified.

The surface relief on the base 1 of the grinding cup holder can be formed on an in particular disk-shaped or annular relief shaped piece which is detachably connected to the base 1. In particular, an exchangeable annular part can be provided, on which the surface relief is formed and which can be screwed to a base body 19 of the base 1 via screws 20. This permits the annular part to be exchanged in a simple manner with advanced wear of the surface relief. It goes without saying that, in principle, it can also be provided for the grinding cup base to form the surface relief on an in particular disk-shaped or annular relief shaped piece which is detachably connected to the grinding cup 2.

### LIST OF REFERENCE SYMBOLS

1 Base
2 Grinding cup
3 Bore
4 Surface
5 Surface region
6 Contour line
7 Surface
8 Indentation
9 Bulge
10 Surface
11 Surface region
12 Contour line
13 Contour line
14 Surface
15 Indentation
16 Bulge
17 Surface region
18 Bore
19 Base body
20 Screws

1. A laboratory mill, comprising:
at least one grinding cup holder for at least one grinding cup (2), wherein the at least one grinding cup holder comprises at least one anti-rotation means configured to hold the grinding cup (2) in a defined, predetermined position relative to the grinding cup holder and/or as a positioning aid, wherein the grinding cup holder comprises, on an axial surface (4) which faces a grinding cup base during grinding operation, wherein the anti-rotation means comprises at least one surface relief, wherein the at least one surface relief is configured to be connected in a form-fitting manner to a mating relief which is complementary to the at least one surface relief on an axial surface (10) of the grinding cup base.

2. The laboratory mill of claim 1, further comprising a grinding cup (2), wherein the grinding cup comprises a surface relief on an axial surface (10), which faces the grinding cup holder of the laboratory mill during a grinding operation, wherein the grinding cup further comprises the grinding cup base, which is configured to be connected in a form-fitting manner to the mating relief which is complementary to the at least one surface relief on the axial surface (4) of the grinding cup holder.

3. The laboratory mill of claim 1, wherein the surface relief is formed by at least one surface region (5, 11) which is formed so as to be recessed or projecting in an axial direction with respect to an adjoining surface region of the axial surface (4), wherein, when the grinding cup (2) is placed on or into a base (1) of the grinding cup holder, at least one recessed or projecting surface region (11) on an axial surface (10) of the grinding cup base engages with at least one projecting or recessed surface region (5) on the axial surface (4) of the grinding cup holder.

4. The laboratory mill of claim 1, wherein the relief at least one surface relief merges in one piece into an adjoining surface region of the axial surface (4) and/or wherein the surface relief comprises a planar relief surface.

5. The laboratory mill of claim 1, wherein the surface relief is formed by a recess or elevation which extends continuously over an entire circumference of the grinding cup (2) or is closed.

6. The laboratory mill of claim 5, wherein, in a plan view of the at least one surface relief, the surface relief comprises a contour profile including at least one outer edge of the surface relief which deviates from an exact circular shape and/or from an exact annular shape, wherein the outer edge comprises at least one change in a curvature behavior in sections in a circumferential direction, and wherein the outer edge forms an undercut for a form fit which acts in the circumferential direction with the mating relief.

7. The laboratory mill of claim 5, wherein, in a plan view of the at least one surface relief, the surface relief comprises a wave-shaped contour profile of at least one outer edge of the surface relief in a circumferential direction, at least in sections, and/or wherein the surface relief forms an inner or outer multi-tooth profile.

8. The laboratory mill of claim 1, wherein at least one centering relief is formed in a base (1) of the grinding cup holder and/or in the grinding cup base, wherein, when a form-fitting connection between the surface relief and the mating relief is formed, the centering relief can be connected in a form-fitting manner to a complementary centering relief on the grinding cup base or on the grinding cup holder in order to center the grinding cup (2) relative to the at least one grinding cup holder.

9. The laboratory mill of claim 1, wherein at least one bore (18) which extends in an axial direction for receiving an anti-rotation pin as further anti-rotation means is provided in and/or on a surface (4) of the grinding cup holder and/or on the surface (10) of the grinding cup base, and wherein the bore (18) is arranged in a surface region of the at least one surface relief.

10. The laboratory mill of claim 1, wherein the surface relief is formed on a disk-shaped or annular ex-changeable part which is detachably connected to the at least one grinding cup holder or to the grinding cup (2).

11. (canceled)

12. The laboratory mill of claim 1, wherein the laboratory mill comprises a centrifugal ball mill.

13. The laboratory mill of claim 1, wherein the laboratory mill comprises a planetary ball mill.
